(19) United States
(12) Patent Application Publication
(10) Pub. No.: US 2004/0239616 A1
(43) Pub. Date: Dec. 2, 2004

(54) Methods and apparatus for receiving user input via time domain reflectometry

(76) Inventor: Ryan V. Collins, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/446,897

(22) Filed: May 28, 2003

(51) Int. Cl. G09G 5/00

(52) U.S. Cl. 345/156

(57) ABSTRACT

In one embodiment a method includes defining an input location and detecting at least in part presence of an input indicator at the input location by employing time domain reflectometry.

### BACKGROUND

Mechanically actuatable user input devices such as keyboards, keypads and push buttons are well known. One problem encountered with such input devices is the requirement that the keys or buttons be mounted for movement to allow for mechanical actuation by the user. If the mounting mechanism fails, the input device may be disabled. Accordingly, the mounting mechanism must be constructed with a high degree of ruggedness and at considerable cost. Keyboards, keypads and push buttons may also take up more space than is desirable, particularly when part of a portable or handheld device.

### BRIEF DESCRIPTION OF THE DRAWINGS

FIG. 1 is a block diagram of a processor-controlled electronic device according to some embodiments.

FIG. 2 schematically illustrates operation and components of a user interface included in the electronic device of FIG. 1 according to some embodiments.

FIG. 3 is similar to FIG. 2, but with schematic representations of equivalent electrical circuit elements substituted for the representations of a user's finger which appear in FIG. 2.

FIG. 4 illustrates in block diagram form components of a TDR (time domain reflectometry) circuit shown in FIGS. 2 and 3.

FIG. 5 is a flow chart that illustrates operations that may be carried out in accordance with some embodiments.

FIG. 6 is a block diagram of an arrangement for providing a numeric user input pad according to some embodiments.

FIG. 7 is a block diagram of an alternative arrangement for providing a numeric user input pad according to some embodiments.

FIG. 8 is a block diagram of another alternative arrangement for providing a numeric user input pad according to some embodiments.

FIG. 9 is a front elevational view of a cellular telephone according to some embodiments.

FIG. 10 is a block diagram representation of the cellular telephone of FIG. 9.

FIG. 11 is a schematic block diagram representation of an elevator call plate according to some embodiments.

### DETAILED DESCRIPTION

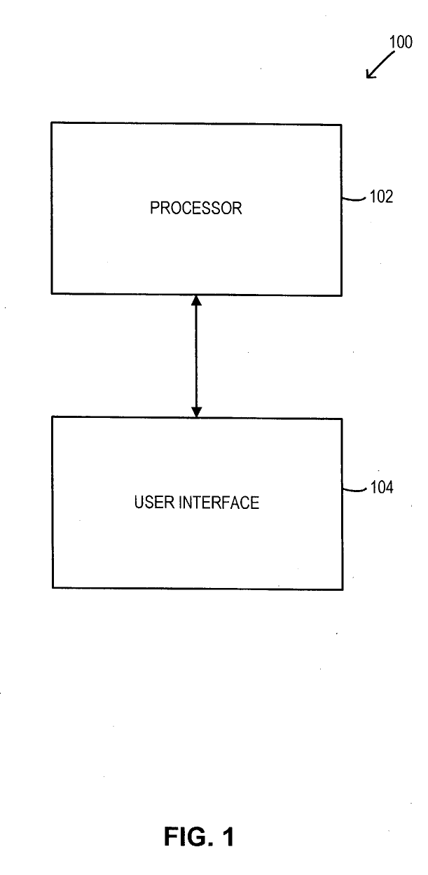

FIG. 1 is a block diagram of a processor-controlled electronic device 100 according to some embodiments. As shown in FIG. 1, the electronic device 100 includes a processor 102, which may be a conventional microprocessor or microcontroller, and a user interface 104 which is coupled to the processor 102. The user interface 102 allows a user of the electronic device 100 to provide input signals to the processor 102 and to perceive information that is output from the processor 102. Other components and functions of the electronic device 100 are not indicated in the drawing, but such other components and functions may all be controlled by the processor.

According to some embodiments, user input functions of the user interface 104 utilize techniques of time domain reflectometry to detect at least some of the user's indications of input to be provided to the processor 102.

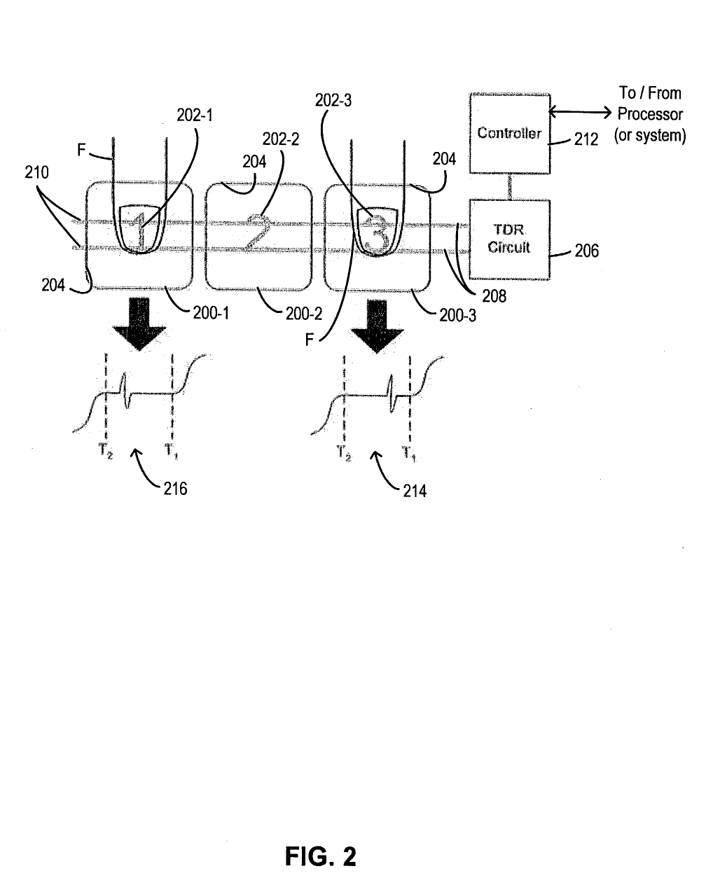

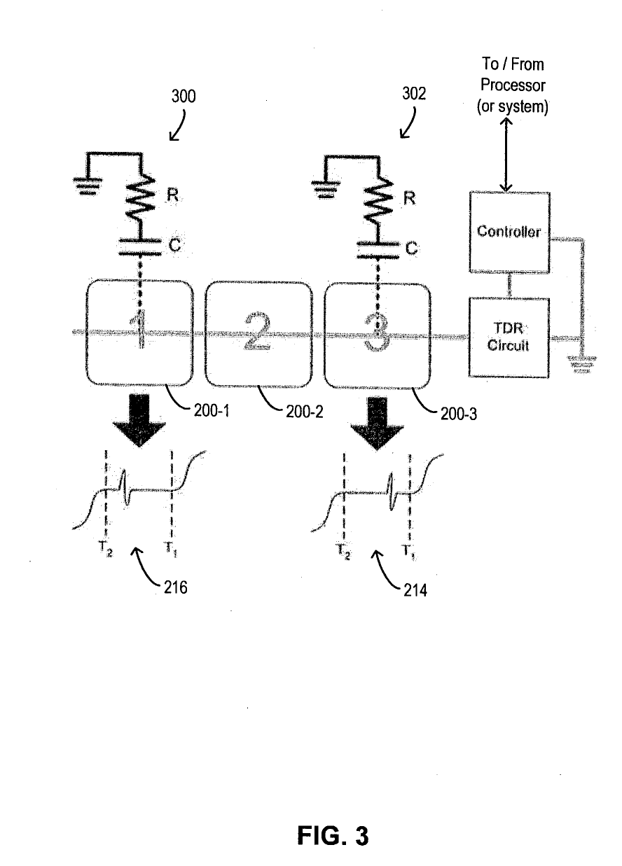

FIGS. 2 and 3 schematically illustrate user input aspects of the user interface 104 of FIG. 1.

In FIGS. 2 and 3 input locations 200-1, 200-2 and 200-3 are shown. The input locations may be a portion of a numeric user input pad (hereinafter a “numeric pad”) that is part of the user interface 104. Each input location includes a respective human-readable symbol or indicium 202-1, 202-2 or 202-3. In the case of the input location 200-1, the indicium 202-1 is the numeral “1”; in the case of the input location 200-2, the indicium 202-2 is the numeral “2”; in the case of the input location 200-3, the indicium 202-3 is the numeral “3”.

Each input location 200-1, 200-2, 200-3 also includes a border 204 which surrounds the respective indicium 202-1, 202-2 or 202-3. Each input location is defined by its respective border 204 and indicium 202-1, 202-2 or 202-3. (Alternatively, input locations may be defined by only one of an indicium and a border; or may be defined by color contrast and/or shading contrast, or by any other visual cue.) The borders 204 and indicia 202-1, 202-2, 202-3 of the input locations 200-1, 200-2, 200-3 may be formed on a surface (not separately indicated) by conventional techniques such as painting, etching, silk screening, stickers, appliques, etc.

If the user wishes to provide an input that corresponds to one of the indicia 202-1, 202-2, 202-3, the user may place his or her finger F on the input location that includes the particular indicium. For example, if the user wishes to input the number “1” to the device 100, he or she may place his or her finger on the input location 200-1.

Time domain reflectometry circuitry 206 is provided to detect input indications at the input locations 200-1, 200-2, 200-3. A conductor or conductors 208 are coupled to the TDR circuitry 206 and extend adjacent to the input locations such that the input locations are defined along the conductor or conductors 208. Each conductor 208 may be formed by a metal trace, or an insulated or uninsulated wire, or by any other continuous linear conductive material, including conductive plastics or ceramics. The far end or ends 210 of the conductor or conductors 208 may be open, terminated, grounded or shorted.

A controller 212 is coupled to the TDR circuitry 206. The controller 212 may be in data communication with the processor 102 (FIG. 1, not shown in FIGS. 2 and 3) or with a system which may or may not include the processor 102.

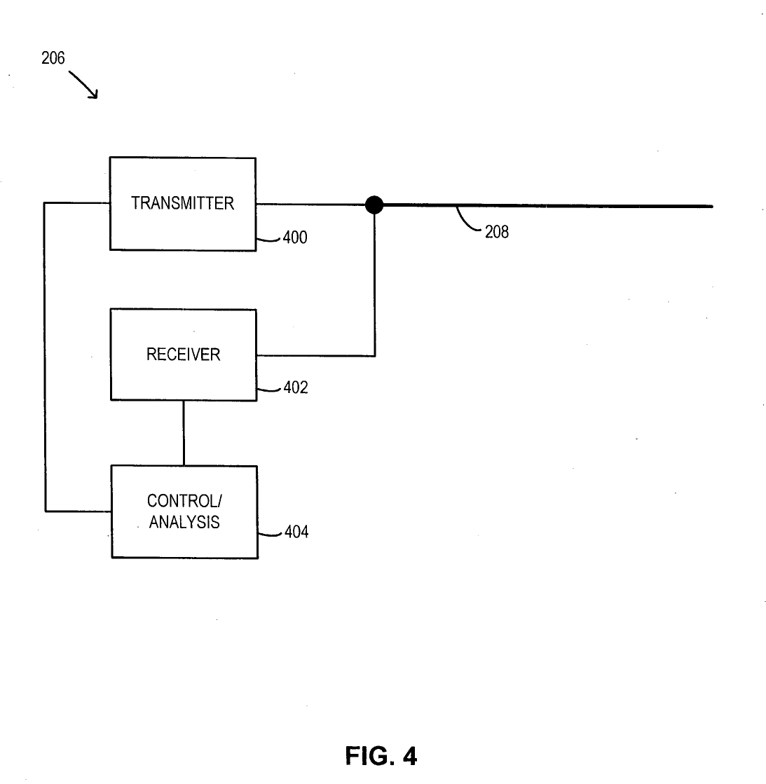

FIG. 4 is a block diagram that shows some details of the TDR circuitry 206.

The TDR circuitry 206 includes a transmitter circuit 400 that is coupled to the conductor 208. Also included in the TDR circuitry 206 is a receiver circuit 402 that is also coupled to the conductor 208. The TDR circuitry further includes a control/analysis circuit 404 that is coupled to the transmitter circuit 400 and the receiver circuit 402. (Some or all of the functions of the control/analysis circuit 404, as described below, may alternatively be performed by the controller 212 (FIG. 2).)

The presence of a user's finger at a particular point along a conductor has the effect of introducing an electrical discontinuity at that point. In particular, a user's finger can be modeled as a resistance and a capacitance in series to ground, as indicated as equivalent circuits at 300 and 302 in FIG. 3.

If the user's finger is located at the input location 200-3, a reflection (indicated at 214) of an interrogation signal from the TDR circuitry 206 is generated by the presence of the finger at the input location 200-3 and is received back at the TDR circuitry at a timing (relative to the interrogation signal) that is close to a beginning time point T₁ of a time window. If the user's finger is located at the input location 200-1, a reflection (indicated at 216) of the interrogation signal is generated by the presence of the finger at the input location 200-1 and is received back at the TDR circuitry at a timing that is close to an ending time point T₂ of the time window. It will be appreciated that a reflection received at an intermediate timing as compared to the reflections shown at 214 and 216 would be indicative of the presence of the user's finger at the input location 200-2. Thus the TDR circuitry is able to detect, based on the presence and timing of a reflection of an interrogation signal, that the user has made a particular indication of a desired input by placing his or her finger at a particular input location.

(It is noted that FIG. 2 shows fingers of a user located at both input locations 200-1 and 200-3 for the sake of a comparative illustration, and that equivalent circuits are shown in FIG. 3, at 300 and 302, in conjunction with those input locations. However, according to some embodiments, at any one time either a user's finger is not present at any of the input locations 200-1, 200-2, 200-3, or a user's finger is present at only one of the input locations.)

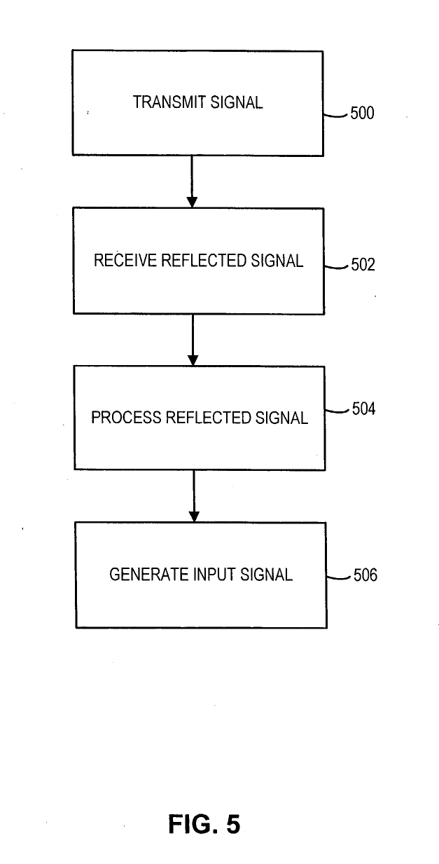

Operation of the user input arrangement of FIGS. 1-4 will now be described with reference to FIG. 5. At 500 in FIG. 5, the TDR circuitry 206 (FIG. 2) transmits an interrogation signal along the conductor or conductors 208. In particular, the transmitter circuit 400 (FIG. 4) may transmit the interrogation signal (e.g., a pulse) along the conductor 208 under the control of, and at a timing determined by, the control/analysis circuit 404.

Assuming that the user has placed a finger at one of the input locations 200-1, 200-2, 200-3, the presence of the user's finger at the particular input location creates an electrical discontinuity at a point along the conductor that corresponds to the input location at which the finger is present. The existence of the electrical discontinuity generates a reflection of the interrogation signal, and the reflected signal is received, as indicated at 502 in FIG. 5, by the receiver circuit 402. Then, at 504, the reflected signal is processed by the control/analysis circuit 404. In particular, the control/analysis circuit may detect the timing at which the reflected signal was received at the receiver circuit 402 relative to the time of transmission of the interrogation signal. As discussed above, this timing indicates a particular one of the input locations at which the user's finger is located.

Based on the detected timing, the control/analysis circuit 404 and/or the controller 212 generates an input signal, as indicated at 506 in FIG. 5, to be provided to the processor 102 (FIG. 1). For example, if the user's finger is placed at the input location 200-1, then the input signal “1” (or a code corresponding thereto) is generated. If the user's finger is placed at the input location 200-2, then the input signal “2” (or a code corresponding thereto) is generated. If the user's finger is placed at the input location 200-3, then the input signal “3” (or a code corresponding thereto) is generated.

In some embodiments, the TDR circuitry 206 is operated (e.g., under the control of the controller 212) such that interrogation signals are transmitted along the conductor or conductors 208 at regular and frequent intervals, e.g., every tenth or one-hundredth or one-thousandth of a second. Also, a conventional “debounce” algorithm may be employed so that a single input indication is not misinterpreted as more than one input indication.

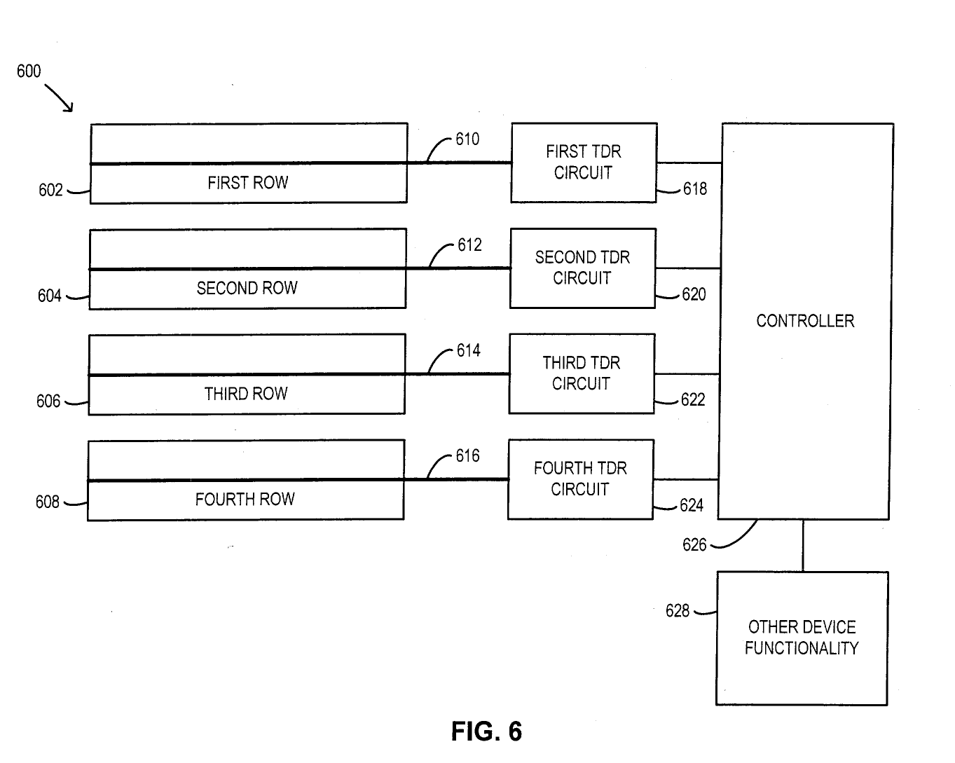

FIG. 6 is a block diagram of an arrangement for providing a numeric pad 600 according to some embodiments.

The numeric pad 600 includes a first row 602 of input locations (individual input locations not separately shown), a second row 604 of input locations (individual input locations not separately shown), a third row 606 of input locations (individual input locations not separately shown), and a fourth row 608 of input locations (individual input locations not separately shown). For example, the first row may consist of input locations respectively corresponding to the numbers “1”, “2”, “3” like the input locations shown in FIGS. 2 and 3. The second row may consist of input locations respectively corresponding to the numbers “4”, “5”, “6”, as in the standard telephone keypad. Also like the standard telephone keypad, the third row may consist of input locations respectively corresponding to the numbers “7”, “8”, “9”; and the fourth row may consist of input locations respectively corresponding to the symbol “*”, the number “0”, and the symbol “#”. Thus the numeric pad 600 could be suitable for use in a telephone.

A first conductor 610 is associated with the first row 602 such that the input locations of the first row are defined along the first conductor and the first conductor is in juxtaposition with the input locations of the first row. A second conductor 612 is associated with the second row 604 such that the input locations of the second row are defined along the second conductor. A third conductor 614 is associated with the third row 606 such that the input locations of the third row are defined along the third conductor. A fourth conductor 616 is associated with the fourth row 608 such that the input locations of the fourth row are defined along the fourth conductor.

First TDR circuitry 618 is coupled to the first conductor 610. Second TDR circuitry 620 is coupled to the second conductor 612. Third TDR circuitry 622 is coupled to the third conductor 614. Fourth TDR circuitry 624 is coupled to the fourth conductor 616. The TDR circuitry 618-624 may be of the type described in connection with FIGS. 2-4. A controller 626 is coupled to all of the TDR circuitry 618-626 and connects the numeric pad 600 to the other functionality (represented by block 628) of the device, which may include a processor (not separately shown) that controls the device.

The manner in which input may be provided through the numeric pad 600 has been indicated in the above discussion of FIGS. 2-5. It will be understood that respective interrogation signals may be transmitted along the associated conductors 610-616 by the TDR circuitry 618-624 to interrogate each of the rows of input locations. Some or all of the interrogation signals may be synchronized; alternatively, some or all of the interrogation signals may be provided at staggered timings.

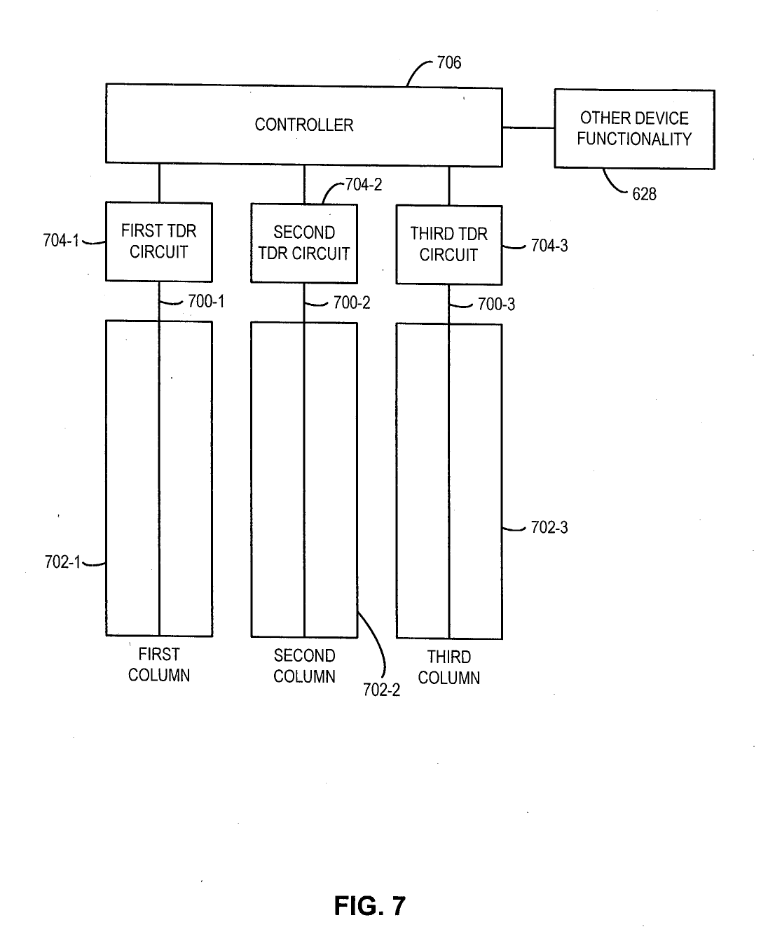

A numeric pad arrangement according to other embodiments is illustrated in FIG. 7.

The arrangement of FIG. 7 differs from that of FIG. 6 principally in that the conductors extend column-wise rather than row-wise. Specifically, each of the conductors 700 is associated with a respective column 702 of input locations. To again substantially reproduce the layout of a standard telephone keypad, the first column 702-1 may consist of input locations (not separately shown) corresponding to the numbers “1”, “4”, “7” and the symbol “*”; the second column 702-2 may consist of input locations (not separately shown) corresponding to the numbers “2”, “5”, “8”, “0”; and the third column 702-3 may consist of input locations (not separately shown) corresponding to the numbers “3”, “6”, “9” and the symbol “#”.

As before, each conductor 700 is coupled to respective TDR circuitry 704, but in this case the number of TDR circuits is three rather than four, which may provide some cost savings relative to the embodiments of FIG. 6. Also as before, a controller 706 may be coupled to the TDR circuitry 704 and may connect the numeric pad to the other device functionality. Operation of the embodiments of FIG. 7 may be substantially the same in principle as the above-described operation of the embodiments of FIG. 6.

Although the TDR circuitry is shown as being situated on the right side of the rows in FIG. 6, and “above” the columns in FIG. 7, neither of these arrangements is required. As alternatives, some or all of the TDR circuitry may be to the left of the rows or “below” the columns.

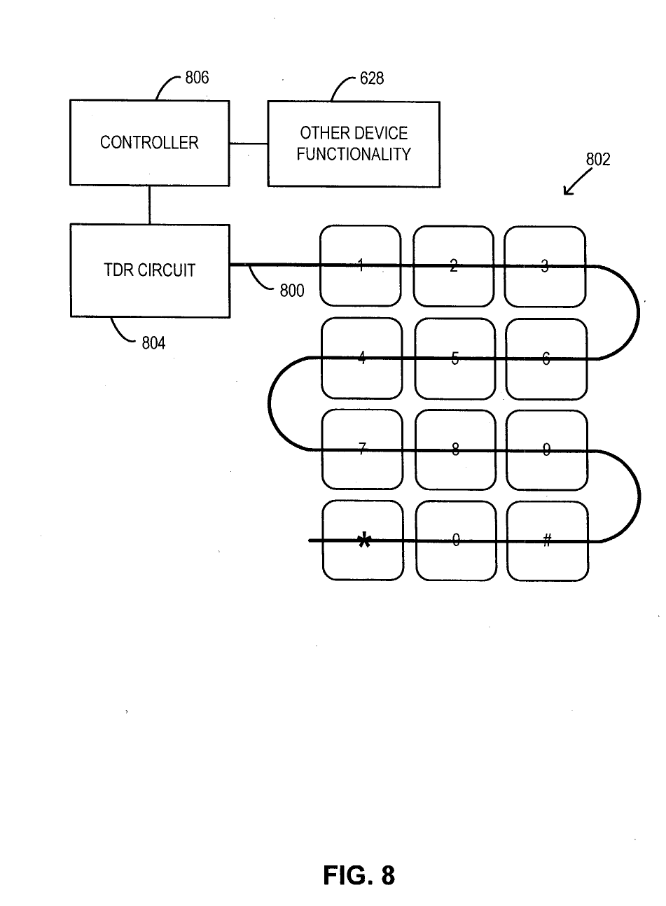

An arrangement according to still other embodiments is illustrated in FIG. 8.

Instead of the linear conductors of FIGS. 2, 3, 6 and 7, the arrangement of FIG. 8 may employ a serpentine conductor 800 which crosses through all 12 of the input locations of a numeric pad 802. A single TDR circuit 804 is coupled to the conductor 800 to interrogate all 12 of the input locations. A controller 806 connects the TDR circuit 804 to the other device functionality.

In place of the row-wise serpentine path for the conductor 800 shown in FIG. 8, a column-wise serpentine path may be provided. As another alternative, a diagonal-wise path may be employed. Still other serpentine paths (e.g., with each course of the path corresponding to only part of a row or column) may also be used. It should also be understood that linear conductors arranged along parallel diagonals may be used in other alternative embodiments.

The numeric pads shown herein may be suitable, with or without changes in position of the indicia, or changes in the particular indicia, for use with devices other than telephones. For example, the “#” symbol may be dropped and arithmetic symbols such as “+”,“−”,“/”,“=” may be added (with an increase in the total number of input locations), and the resulting numeric pad may be used in a portable calculator or the like.

The principles described herein are also applicable to keyboards that include alphabetic or alpha-numeric characters and/or other symbols of a standard typewriter or computer keyboard. Thus respective conductors, each coupled to a respective TDR circuit, may be associated with columns, rows or diagonals of a set of input locations patterned like a “QWERTY” keyboard. A TDR “keyboard” of this type (which lacks movable keys) may be used as a component of a desktop or portable computer to input alphabetic, numeric and other character input signals and/or control signals. One or more serpentine conductors may alternatively be employed.

If it is desired to reduce the planar extent of a TDR “keyboard” or numeric pad by reducing the area for each input location to a size that is too small for a user's fingers, a conductive stylus may be used to make input indications by placing the stylus tip in respective input locations. In this regard, it is assumed that the conductive stylus presents some recognizable electrical load to the TDR conductor. A TDR input device of that size may be suitable to be used as a component of a PDA (personal digital assistant).

A TDR-based user input device or devices may also be used as part of a touchscreen.

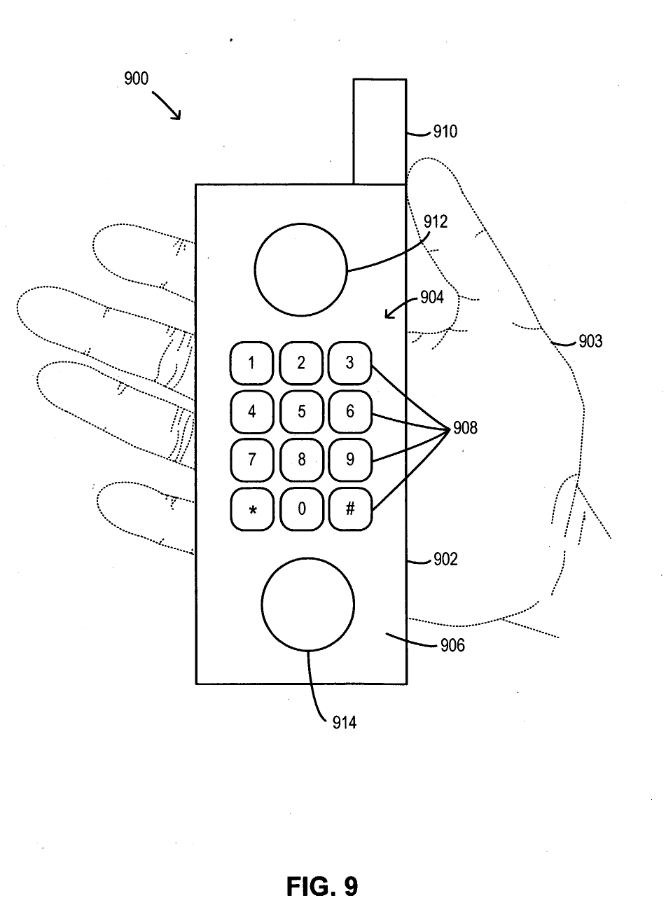

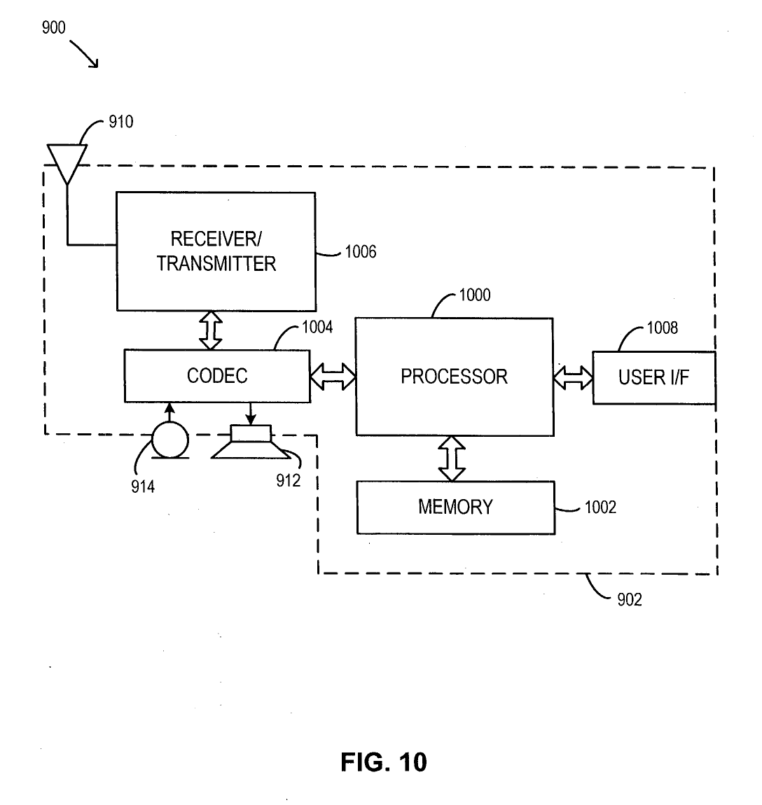

A cellular telephone 900 provided according to some embodiments will now be described with reference to FIGS. 9 and 10. FIG. 9 is a front elevational view of the cellular telephone, and FIG. 10 is a block diagram illustration of the cellular telephone.

Referring initially to FIG. 9, the cellular telephone 900 includes a housing 902 that is shaped and sized to fit within a user's hand (indicated in phantom at 903). The telephone 900 also includes a numeric pad 904 provided on a front surface 906 of the housing. The numeric pad 904 is formed of input locations 908 that may be interrogated by time domain reflectometry in accordance with one or more of the embodiments described above. As is customary, the numeric pad may be employed by the user of the telephone 900 to actuate transmission of dialing signals by the telephone.

The cellular telephone 900 also includes an antenna 910, and a speaker 912 and a microphone 914 mounted at the front surface 906 of the housing 902. In addition to the numeric pad which is shown, other user controls which are not shown may be provided on the front surface 906 of the housing or elsewhere on the housing. Such other controls may include push buttons and/or TDR-interrogated input locations. The front surface 906 may also have mounted thereon one or more displays, which are not shown.

Referring to FIG. 10, the cellular telephone 900 also includes the following components mounted within the housing 902: a processor 1000, one or more memory components 1002, a codec 1004 and a receiver/transmitter 1006. The processor 1000 is in data communication with the memory components 1002 and the codec 1004. The receiver/transmitter 1006 is operatively coupled to the codec 1004 and to the antenna 910. The microphone 914 is operatively coupled to the codec 1004 to provide voice input signals to the codec 1004. The speaker 912 is also operatively coupled to the codec 1004 and is driven by the codec 1004 to provide audible output.

The processor 1000 is operatively coupled to a user interface, which is represented by block 1008 in FIG. 10 and which includes the input/output devices referred to in connection with FIG. 9. In particular, the user interface 1008 includes the TDR-interrogated numeric pad 904, including the necessary conductor or conductors positioned adjacent to and parallel to the front surface of the housing, and TDR and control circuitry, as described in connection with one or more of FIGS. 2-8 and mounted within the housing 902. All of the components of the cellular telephone 900 other than the TDR-based user controls may be conventional.

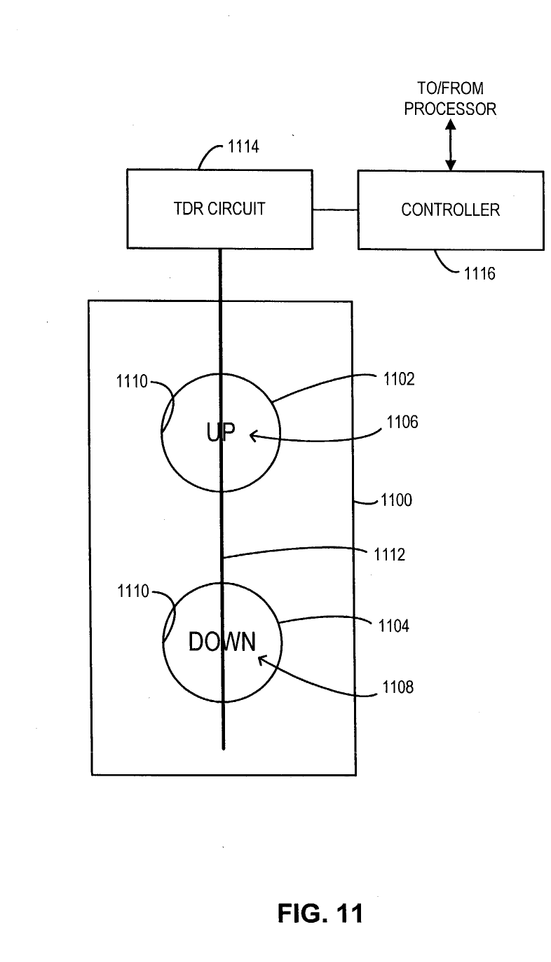

FIG. 11 is a schematic block diagram representation of an elevator call plate 1100 according to some embodiments. Input locations 1102 and 1104 are defined on the call plate 1100. The input location 1102 includes an indicium or control indication 1106, namely the word “UP”, and the input location 1104 includes an indicium or control indication 1108, namely the word “DOWN”. Each input location 1102 and 1104 also includes, and is defined by, a circular border 1110. The indicia 1106, 1108 and the borders 1110 may be formed on the call plate 1100 by conventional practices such as printing, silk screening, etching, embossing, etc.

A conductor 1112 is associated with the call plate 1100 and is positioned such that the input locations 1102, 1104 are defined along the conductor 1112. The conductor 1112 is coupled to TDR circuitry 1114. A controller 1116 connects the TDR circuitry 1114 to a processor (not shown) that controls an elevator (not shown).

The TDR circuitry may operate, in the same manner described above in connection with FIGS. 2 and 3, to detect the presence of a user's finger (not shown) at either one of the input locations 1102, 1104. If a user makes an input indication by placing his or her finger at the input location 11102, the input indication is detected by the TDR circuitry 1114, and in response to the input indication, the TDR circuitry 1114 and/or the controller 1116 generate a control signal to indicate that the user has requested that the elevator transport him or her in an upward direction. The elevator is then operated accordingly.

If a user makes an input indication by placing his or her finger at the input location 1104, the input indication is detected by the TDR circuitry 1114, and in response to the input indication, the TDR circuitry 114 and/or the controller 116 generate a control signal to indicate that the user has requested that the elevator transport him or her in a downward direction. The elevator is then operated accordingly.

It will be appreciated that in the case of a call plate located at the top or bottom floor served by the elevator, the call plate may have only one input location.

The elevator call plate of FIG. 11 is an example of embodiments in which a TDR-based user input device is employed to input control signals rather than data signals. Other control-oriented TDR-based user input devices may include numeric floor designation inputs for the interior of an elevator car.

More generally, in some embodiments TDR-based user input devices may be employed to control or input data into any electronic device, including household appliances, handheld consumer electronics products (e.g. cameras, PDAs, disk and tape players, remote controls, etc.), vehicle controls, industrial equipment controls, etc.

A TDR-based user input device according to an embodiment described herein may have no moving parts and may enjoy cost and/or durability advantages over conventional input devices such as mechanically actuated keyboards, keypads and push buttons. In addition, a TDR-based user input device according to an embodiment described herein may be provided with a sealed housing or under a sealing surface so as not to be affected by environmental factors such as spilled liquids or dust build-up.

Thus, in one embodiment a method includes defining an input location, and detecting at least in part presence of an input indicator at the input location by employing time domain reflectometry.

In another embodiment, a method includes transmitting a first signal along a conductor, receiving a second signal that is a reflection of the first signal, and generating, at least in part based on the second signal, an input signal that indicates at least in part an input indication from a human operator.

In still another embodiment, an apparatus includes a conductor, at least one input location defined along the conductor, and time domain reflectometry circuitry coupled to the conductor.

In yet another embodiment, an apparatus includes a processor and a user interface coupled to the processor, and the user interface includes a conductor and time domain reflectometry (TDR) circuitry coupled to the conductor and capable of detecting an input indication adjacent to the conductor, the TDR circuitry also being connected to the processor.

As used herein and in the appended claims:

“control indication” refers to an input to control operation of a device;

“control signal” refers to a signal that controls operation of a device;

“conductor” refers to a wire or other object that is capable of conducting an electric charge;

“human-readable symbol” refers to a sign or representation that is perceptible by one or more of the human senses;

“input indication” refers to a motion or gesture by a human operator to provide an input signal to a device;

“input indicator” refers to a human operator's finger or another part of a human operator's body or a stylus or other object held by a human operator;

“input location” refers to a location that includes a human-readable indication that the location may be accessed by an input indicator to provide input from a human operator;

“input signal” refers to a signal going into an electronic device;

“processor” refers to a signal processing device including a microprocessor or a microcontroller;

“time domain reflectometry” refers to analysis of a conductor by sending a signal into the conductor and examining and/or detecting the timing of a reflection of the signal;

“time domain reflectometry circuitry” refers to circuitry that is capable of performing time domain reflectometry; and

“user interface” refers to one or more components of a device by which a user interacts with or receives output from the device.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
defining an input location; and
detecting at least in part presence of an input indicator at the input location by employing time domain reflectometry.

2. The method of claim 1, further comprising:
generating an input signal in response to the detected presence of the input indicator.

3. The method of claim 2, wherein the input signal is indicative of an alphabetic character.

4. The method of claim 2, wherein the input signal is indicative of a number.

5. The method of claim 2, wherein the input signal is a control signal.

6. A method comprising:
transmitting a first signal along a conductor;
receiving a second signal that is a reflection of the first signal; and
generating, at least in part based on the second signal, an input signal that indicates at least in part an input indication from a human operator.

7. The method of claim 6, wherein the generating includes detecting a timing of the second signal relative to the first signal.

8. The method of claim 7, wherein the input signal is indicative of an alphabetic character.

9. The method of claim 7, wherein the input signal is indicative of a number.

10. The method of claim 7, wherein the input signal is a control signal.

11. The method of claim 6, wherein the input indication includes placement of the human operator's finger at a position adjacent the conductor.

12. The method of claim 6, wherein the input indication includes placement of a stylus at a position adjacent the conductor.

13. An apparatus comprising:
a conductor;
at least one input location defined along the conductor; and
time domain reflectometry circuitry coupled to the conductor.

14. The apparatus of claim 13, wherein the at least one input location includes at least one human-readable symbol.

15. The apparatus of claim 13, wherein the at least one input location includes a plurality of input locations, and each of the input locations includes a respective human-readable symbol.

16. The apparatus of claim 15, wherein the human-readable symbols are numerals.

17. The apparatus of claim 15, wherein the human-readable symbols are alphabetic characters.

18. The apparatus of claim 15, wherein the human-readable symbols are control indications.

19. An apparatus comprising:
a processor; and
a user interface coupled to the processor;
wherein the user interface includes:
a conductor; and
time domain reflectometry (TDR) circuitry coupled to the conductor and capable of detecting an input indication adjacent to the conductor, the TDR circuitry also being connected to the processor.

20. The apparatus of claim 19, wherein the user interface includes a plurality of input locations arranged along the conductor.

21. The apparatus of claim 20, wherein each input location includes a respective human-readable symbol.

22. The apparatus of claim 21, wherein the human-readable symbols are numerals.

23. The apparatus of claim 21, wherein the human-readable symbols are alphabetic characters.

24. The apparatus of claim 21, wherein the human-readable symbols are control indications.

25. The apparatus of claim 19, wherein the apparatus is a telephone controlled by the processor, and the user interface includes a numeric pad which is capable of being operated by a user of the telephone to actuate transmission of dialing signals, at least a portion of the numeric pad being located in juxtaposition with the conductor.

26. The apparatus of claim 19, wherein at least a portion of the apparatus is capable of being held in a user's hand.

27. The apparatus of claim 26, wherein the apparatus is a telephone controlled by the processor, and the user interface includes a numeric pad which is capable of being operated by a user of the telephone to actuate transmission of dialing signals, at least a portion of the numeric pad being located in juxtaposition with the conductor.
